(19) United States
(12) Patent Application Publication
(10) Pub. No.: US 2025/0173774 A1
(43) Pub. Date: May 29, 2025

(54) MULTIMEDIA CONTENT RECOMMENDATION METHOD AND APPARATUS, DEVICE, AND STORAGE MEDIUM

(71) Applicant: Beijing Zitiao Network Technology Co., Ltd., Beijing (CN)

(72) Inventors: Jinghua LI, Beijing (CN); Chuanqi JING, Beijing (CN)

(21) Appl. No.: 18/931,682

(22) Filed: Oct. 30, 2024

(30) Foreign Application Priority Data
Nov. 27, 2023 (CN) 202311595924.6

(51) Int. Cl. G06Q 30/0601

(52) U.S. Cl. CPC G06Q 30/0631

(57) ABSTRACT

Embodiments of the present application provide a multimedia content recommendation method and apparatus, a device, and a storage medium. The method includes: determining, for any book, first reading data of the book in a plurality of reading sources, where the reading sources include at least a book recommendation special topic; determining recommendation contribution information of the book recommendation special topic for the book based on the first reading data; and determining a recommendation form of the book based on the recommendation contribution information.

### CROSS REFERENCE TO RELATED APPLICATIONS

This present application claims the benefit of priority to Chinese Application No. 202311595924.6, filed on Nov. 27, 2023, the entire contents of which are incorporated herein by reference.

### TECHNICAL FIELD

Embodiments of the present application relate to the field of data processing technologies, and in particular, to a multimedia content recommendation method and apparatus, a device, and a storage medium.

### BACKGROUND

With an increasing number of users reading various books in a reading application, it is usually possible to support recommending various high-quality books on a bookstore page or publishing corresponding topic content in a topic square of the reading application to recommend various high-quality books, to ensure that users in the reading application can quickly and effectively read various high-quality books.

### SUMMARY

Embodiments of the present application provide a multimedia content recommendation method and apparatus, a device, and a storage medium.

In a first aspect, an embodiment of the present application provides a multimedia content recommendation method. The method includes:
determining, for any book, first reading data of the book in a plurality of reading sources, the reading sources comprising at least a book recommendation special topic;
determining recommendation contribution information of the book recommendation special topic for the book based on the first reading data; and
determining a recommendation form of the book based on the recommendation contribution information.

In a second aspect, an embodiment of the present application provides a multimedia content recommendation apparatus. The apparatus includes:
a reading data determination module, configured to determine, for any book, first reading data of the book in a plurality of reading sources, the reading sources comprising at least a book recommendation special topic;
a recommendation contribution determination module, configured to determine recommendation contribution information of the book recommendation special topic for the book based on the first reading data; and
a book recommendation module, configured to determine a recommendation form of the book based on the recommendation contribution information.

In a third aspect, an embodiment of the present application provides an electronic device. The electronic device includes a processor and a memory, the memory is configured to store a computer program, and the processor is configured to call and run the computer program stored in the memory to perform the multimedia content recommendation method provided in the first aspect of the present application.

In a fourth aspect, an embodiment of the present application provides a computer-readable storage medium for storing a computer program that causes a computer to perform the multimedia content recommendation method provided in the first aspect of the present application.

In a fifth aspect, an embodiment of the present application provides a computer program product, including a computer program/instructions that causes a computer to perform the multimedia content recommendation method provided in the first aspect of the present application.

### BRIEF DESCRIPTION OF THE DRAWINGS

To describe the technical solutions in the embodiments of the present application more clearly, the following briefly describes the accompanying drawings required for describing the embodiments. Apparently, the accompanying drawings in the following description show merely some embodiments of the present application, and a person of ordinary skill in the art may still derive other drawings from these accompanying drawings without creative efforts.

FIG. 1 is a flowchart of a multimedia content recommendation method according to an embodiment of the present application;

FIG. 2 is a flowchart of a process of determining the first reading data and the recommendation contribution information of the book recommendation special topic for the book according to an embodiment of the present application;

FIG. 3 is a flowchart of a process of determining the second reading data and the search contribution information of the book recommendation special topic for the book according to an embodiment of the present application;

FIG. 4 is a schematic block diagram of a multimedia content recommendation apparatus according to an embodiment of the present application; and

FIG. 5 is a schematic block diagram of an electronic device according to an embodiment of the present application.

### DETAILED DESCRIPTION OF EMBODIMENTS

The following clearly and completely describes the technical solutions in the embodiments of the present application with reference to the accompanying drawings in the embodiments of the present application. Apparently, the described embodiments are some but not all of the embodiments of the present application. All other embodiments obtained by a person of ordinary skill in the art based on the embodiments of the present application without creative efforts shall fall within the protection scope of the present application.

It should be noted that terms “first”, “second”, and the like in the specification, claims, and accompanying drawings of the present application are intended to distinguish between similar objects, but do not necessarily indicate a specific order or sequence. It should be understood that the data termed in such a way are interchangeable in proper circumstances so that embodiments of the present application described herein can be implemented in orders except the order illustrated or described herein. Moreover, the terms “comprise”, “include”, “have”, or any other variant thereof are intended to cover non-exclusive inclusion. For example, a process, method, system, product, or server that includes a list of steps or units is not necessarily limited to those expressly listed steps or units, but may include other steps or units not expressly listed or inherent to such process, method, product, or device.

In the embodiments of the present application, words such as “exemplary” or “for example” are used to represent examples, illustrations, or explanations. Any embodiment or solution described as “exemplary” or “for example” in the embodiments of the present application shall not be construed as being more preferred or more advantageous than other embodiments or solutions. Rather, the use of words such as “exemplary” or “for example” is intended to present the concept in a specific manner.

To solve the problem that a large variety of existing book recommendation methods cannot meet specific recommendation requirements of different types of books and greatly reduce the efficiency of book recommendation, the inventive concept of the present application is as follows: For any book, a first reading data of the book in a plurality of reading sources including at least a book recommendation special topic is first determined, to determine a recommendation contribution degree of the book recommendation special topic for the book. Then, a most suitable recommendation form of the book can be determined based on the recommendation contribution degree, thereby improving the efficiency and accuracy of book recommendation. A most suitable recommendation form is determined for any book, to meet specific recommendation requirements of different types of books, and ensure reading attractiveness of any book after the book is recommended in the most suitable recommendation form, thereby improving reading effectiveness after book recommendation.

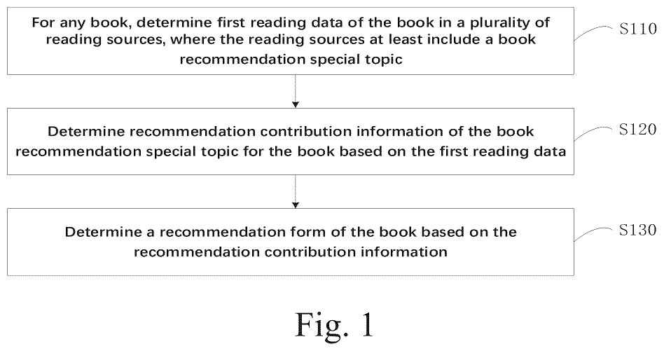

FIG. 1 is a flowchart of a multimedia content recommendation method according to an embodiment of the present application. The method may be performed by a multimedia content recommendation apparatus provided in the present application, where the multimedia content recommendation apparatus may be implemented by any software and/or hardware. Exemplarily, the multimedia content recommendation apparatus may be configured in any electronic device such as an XR device, a server, a mobile phone, a tablet computer, a personal computer, or a smart wearable device. The present application does not limit a specific type of the electronic device.

Specifically, as shown in FIG. 1, the method may include the following steps.

Step 110: Determine, for any book, first reading data of the book in a plurality of reading sources, the reading sources comprising at least a book recommendation special topic.

Among increasingly diversified user leisure and entertainment methods, users can usually read various books in various reading applications to achieve the purpose of relaxation and entertainment. The reading application may be a multimedia application that includes a large quantity of books, such as a novel application, a news application, or a web literature application.

With an increasing number of users reading various books in the reading application, to ensure that each user can quickly and effectively read various high-quality books in the reading application, a book recommendation special topic may be preset in the reading application. The book recommendation special topic may be a special topic square independently developed in the reading application, and can support each user in the reading application to recommend, to other users, each book that the user likes by publishing various special topic content. The special topic content may be a topic post, a book list, multimedia content, or the like that is published by the user in the book recommendation special topic and used for recommending a specific book. In this case, after any user starts the reading application, the user can enter the book recommendation special topic to view a corresponding book recommended in the special topic content published by another user, to quickly and effectively read various high-quality books that the user likes.

In any reading application, a method for supporting a user to read a specific book may include but is not limited to the following three methods. 1) In a reading source (for example, a book display list) other than the book recommendation special topic in the reading application, the user clicks a displayed specific book to read the book. 2) In special topic content that has been published in the book recommendation special topic, the user clicks a specific book recommended in the specific special topic content to read the book. 3) In a search bar of the reading application, the user directly searches for related information about a specific book, and then directly clicks the searched specific book or specific special topic content for recommending the book to read the book.

It can be learned that for any book, when the same book is recommended in different recommendation forms, the book has different attraction to the user, so that a user reading quantity of the same book varies after the same book is recommended in different recommendation forms. Therefore, to ensure efficient book recommendation, the present application needs to set a suitable recommendation form for each book, to attract users to read the book to the greatest extent, thereby improving effective reading after book recommendation. An effective reading quantity of users brought about after book recommendation is affected by the foregoing three different book reading methods.

Therefore, to accurately analyze suitable recommendation forms of each book, for any book, the present application may first determine different reading sources of the book in the reading application. The reading sources may include at least the book recommendation special topic, and may further include, but are not limited to, a book display list (for example, a bookstore) in the reading application.

Then, for any book, actual reading situations of the book by the users in each reading source within a specific historical period are analyzed, to obtain reading data of the book in each reading source, so as to form the first reading data of the book in the plurality of reading sources.

In S120, recommendation contribution information of the book recommendation special topic for the book is determined based on the first reading data.

After the first reading data of any book in the plurality of reading sources is determined, for each reading source, the present application may perform comprehensive processing on reading data of the book in the reading source, to determine a reading traffic of the book in the reading source.

The reading sources of the book may include at least the book recommendation special topic. In this case, the present application may determine the reading traffic of the book in the book recommendation special topic and the reading traffic of the book in the other reading sources. Then, comprehensive analysis is performed on the reading traffic of the book in the book recommendation special topic and the reading traffic of the book in the other reading sources, to determine the recommendation contribution information brought about by the book recommendation special topic for the book.

In S130, a recommendation form of the book is determined based on the recommendation contribution information.

After the recommendation contribution information of the book recommendation special topic for the book is determined, the present application may analyze the recommendation contribution information, to determine whether a proportion of a reading traffic of the book brought about by the book recommendation special topic in a sum of reading traffic of the book exceeds a preset suitable recommendation indicator, thereby analyzing whether the book is suitable for being recommended by using the book recommendation special topic. If the book recommendation special topic can bring a large quantity of user reading traffic when the book is recommended by using the book recommendation special topic, it indicates that the book recommendation special topic is suitable for recommending the book. In this case, the book recommendation special topic may be determined as a suitable recommendation form of the book.

It may be understood that for any book, if a recommendation form of the book is to recommend the book through target special topic content in the book recommendation special topic, the target special topic content may include but is not limited to a cover, a name, and a recommendation text of the book, so that a user can directly browse key description content of a recommended book, thereby improving efficiency of book recommendation.

According to the technical solution provided in this embodiment of the present application, for any book, first reading data of the book in a plurality of reading sources including at least a book recommendation special topic is first determined, to determine a recommendation contribution degree of the book recommendation special topic for the book. Then, a most suitable recommendation form of the book can be determined based on the recommendation contribution degree, thereby improving the efficiency and accuracy of book recommendation. A most suitable recommendation form is determined for any book, to meet specific recommendation requirements of different types of books, and ensure reading attraction of any book after the book is recommended in the most suitable recommendation form, thereby improving reading effectiveness after book recommendation.

As an optional implementation of the present application, to improve the efficiency and accuracy of book recommendation, the present application may separately describe in detail a specific process of determining, for any book, first reading data of the book in a plurality of reading sources, and determining recommendation contribution information of the book recommendation special topic for the book based on the first reading data.

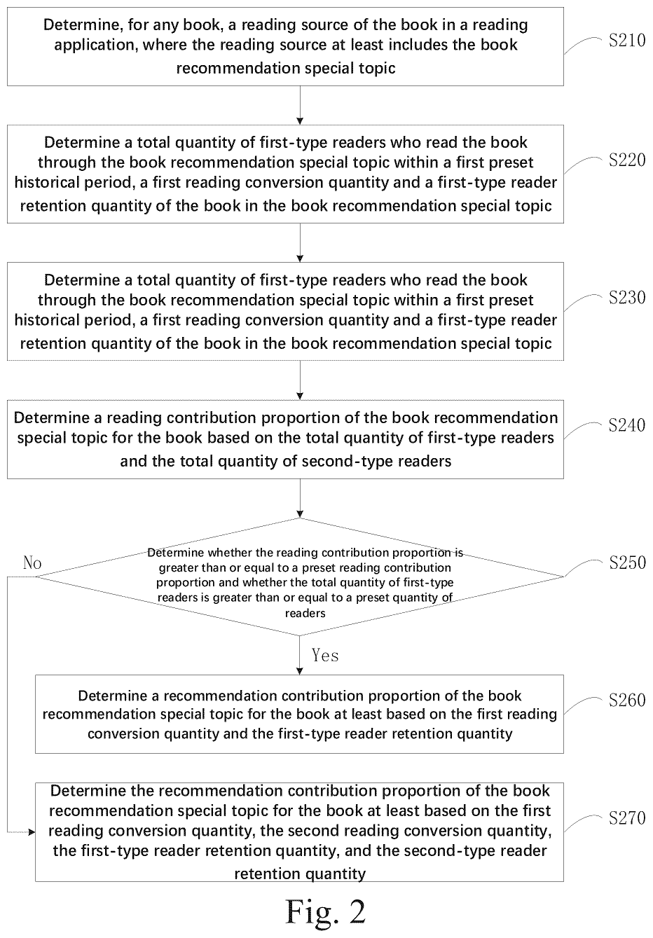

FIG. 2 is a flowchart of a process of determining the first reading data and the recommendation contribution information of the book recommendation special topic for the book according to an embodiment of the present application. As shown in FIG. 2, the method may specifically include the following steps.

Step 210: Determine, for any book, reading sources of the book in a reading application, the reading sources comprising at least a book recommendation special topic.

For any book, to analyze a reading situation of the book in the reading application in all aspects, the present application first determines each reading source of the book in the reading application, for example, a book recommendation special topic for recommending the book, a book display list in the reading application (that is, a homepage of a bookstore), and the like.

It may be understood that an object of the present application is to determine whether a suitable recommendation form of any book is the book recommendation special topic. Therefore, the reading sources of the book may include at least the book recommendation special topic.

Step 220: Determine a total quantity of first-type readers who read the book through the book recommendation special topic within a first preset historical period, a first reading conversion quantity and a first-type reader retention quantity of the book in the book recommendation special topic.

To accurately analyze a specific reading situation of any book in different reading sources, the present application may preset a historical duration to determine the first preset historical period in the present application, for example, the recent 14 days. In addition, readers who read the book through the book recommendation special topic are used as first-type readers in the present application.

In this case, as there may be a plurality of special topic content in the book recommendation special topic that recommend the same book, the present application may search, in the book recommendation special topic, for a total quantity of first-type readers who read the book through corresponding special topic content in the book recommendation special topic within the first preset historical period. The total quantity of first-type readers may indicate a reading traffic level brought about by the book recommendation special topic for the book.

In addition, the present application may determine a quantity of first-type readers who read the book through the book recommendation special topic in a real and effective manner, to obtain the first reading conversion quantity of the book in the book recommendation special topic. The first reading conversion quantity may be a quantity of first-type readers who read the book through the book recommendation special topic and whose number of read pages is greater than a preset number of pages. In addition, for the first-type readers who read the book through the book recommendation special topic, whether each of the first-type readers continuously reads the book within a preset duration (for example, 2 days) is determined, and a quantity of first-type readers who continuously read the book within the preset duration (for example, 2 days) is determined, to obtain the first-type reader retention quantity of the book in the book recommendation special topic.

In S230, a total quantity of second-type readers who read the book through other reading sources within the first preset historical period, a second reading conversion quantity and a second-type reader retention quantity of the book in the other reading sources are determined.

Similarly, readers who read the book through the other reading sources in the reading application may be used as second-type readers in the present application.

In this case, the present application may search, in each of the other reading sources, for a total quantity of second-type readers who read the book through the other reading source within the first preset historical period. The total quantity of second-type readers may indicate a reading traffic level brought about by the other reading source for the book.

In addition, the present application may determine a quantity of second-type readers who read the book through the other reading source in a real and effective manner, to obtain the second reading conversion quantity of the book in the other reading sources. The second reading conversion quantity may be a quantity of second-type readers who read the book through the other reading source and whose number of read pages is greater than the preset number of pages. In addition, for the second-type readers who read the book through the other reading source, whether each of the second-type readers continuously reads the book within a preset duration (for example, 2 days) is determined, and a quantity of second-type readers who continuously read the book within the preset duration (for example, 2 days) is determined, to obtain the second-type reader retention quantity of the book in the other reading source.

It may be understood that S220 and S230 are separate determination of actual reading data of the book in the book recommendation special topic and the other reading sources, and there is no sequential relationship between the two steps. The two steps may be performed simultaneously, or may be performed in sequence. This is not limited in the present application.

In S240, a reading contribution proportion of the book recommendation special topic for the book is determined based on the total quantity of first-type readers and the total quantity of second-type readers.

For any book, after a total quantity of first-type readers who read the book through the book recommendation special topic and a total quantity of second-type readers who read the book through the other reading sources are determined, the present application may determine a sum of the total quantity of first-type readers and the total quantity of second-type readers, to obtain a total quantity of readers of the book in the reading application. Then, a ratio of the total quantity of first-type readers to the total quantity of readers is calculated, to obtain the reading contribution proportion of the book recommendation special topic for the book, thereby indicating a reading traffic level brought about by the book recommendation special topic for the book.

In S250, it is determined whether the reading contribution proportion is greater than or equal to a preset reading contribution proportion, and whether the total quantity of first-type readers is greater than or equal to a preset quantity of readers. If yes, step S260 is performed; or if no, step S270 is performed.

The reading traffic of any book may be completely driven by the book recommendation special topic, or may be driven by the other reading sources in the reading application. Different traffic driving methods of the book are different in the recommendation contribution information brought about by the book recommendation special topic for the book.

Therefore, for any book, the present application may analyze, by determining whether the reading contribution proportion is greater than or equal to the preset reading contribution proportion, and whether the total quantity of first-type readers is greater than or equal to the preset quantity of readers, which reading source specifically drives the reading traffic of the book, so that a suitable recommendation form can be subsequently used to recommend the book efficiently and accurately.

Exemplarily, the preset reading contribution proportion may be 80%, and the preset quantity of readers may be 800. The specific parameter values are merely examples, and are not limited in the present application.

In S260, the recommendation contribution information of the book recommendation special topic for the book is determined at least based on the first reading conversion quantity and the first-type reader retention quantity.

If the reading contribution proportion of the book recommendation special topic for the book is greater than or equal to the preset reading contribution proportion, and the total quantity of first-type readers is greater than or equal to the preset quantity of readers, it indicates that the reading traffic of the book is driven by the book recommendation special topic. In this case, the present application may calculate the recommendation contribution information of the book recommendation special topic for the book by using at least the first reading conversion quantity and the first-type reader retention quantity that are related to when the book is read through the book recommendation special topic.

In some implementations, for the recommendation contribution information of the book recommendation special topic for the book, the present application may specifically determine the recommendation contribution information by using the following steps: determining a first reading conversion rate of the book in the book recommendation special topic based on the first reading conversion quantity and first exposure times of target special topic content in the book recommendation special topic, the target special topic content being used for recommending the book; determining a minimum reading duration between a reading duration of readers who read the book through the book recommendation special topic and a preset reading duration, and a first correction coefficient corresponding to the first exposure times; and determining the recommendation contribution information of the book recommendation special topic for the book based on the first reading conversion rate, the first-type reader retention quantity, the minimum reading duration, and the first correction coefficient.

In other words, to accurately analyze a specific reading situation of the book through the book recommendation special topic, the present application may first determine target special topic content in the book recommendation special topic for recommending the book. Then, first exposure times of the target special topic content within the first preset historical period is determined, and a ratio of the first reading conversion quantity to the first exposure times of the target special topic content may be used to determine the first reading conversion rate of the book in the book recommendation special topic. In addition, as different exposure times may also affect a quantity of readers of the book, the present application may set a suitable adjustment coefficient for the first exposure times of the target special topic content, to use the coefficient as the first correction coefficient in the present application.

The recommendation contribution information brought about by the book recommendation special topic for the book is also affected by a specific reading duration of the book read through the book recommendation special topic. Therefore, the present application may further obtain a specific reading duration of each of the first-type readers who read the book through the book recommendation special topic within the first preset historical period, to use the specific reading duration as the reading duration of the readers in the present application. Then, a minimum reading duration between the reading duration of each of the readers and a preset reading duration (for example, 30 minutes) may be determined.

Further, the recommendation contribution information of the book recommendation special topic for the book is determined based on a product of the first reading conversion rate, the first-type reader retention quantity, the minimum reading duration, and the first correction coefficient.

Exemplarily, when a reading contribution proportion of the book recommendation special topic for a target book is greater than or equal to a preset reading contribution proportion (for example, 80%), and a total quantity of first-type readers is greater than or equal to a preset quantity of readers (for example, 800), a calculation method for the recommendation contribution information of the book recommendation special topic for the book may be as follows: ctr1*cvr1*min(duration, 30)*gama1.

In the foregoing formula, ctr1 may be the first reading conversion rate of the book in the book recommendation special topic, cvr1 may be the first-type reader retention quantity of the book in the book recommendation special topic, duration may be the reading duration of each of the first-type readers who read the book through the book recommendation special topic within the first preset historical period, min(duration, 30) may be the minimum reading duration between the reading duration of the readers who read the target book through the book recommendation special topic and the preset reading duration, and gama1 may be the first correction coefficient.

In S270, the recommendation contribution information of the book recommendation special topic for the book is determined at least based on the first reading conversion quantity, the second reading conversion quantity, the first-type reader retention quantity, and the second-type reader retention quantity.

If the reading contribution proportion of the book recommendation special topic for the book is less than the preset reading contribution proportion, or the total quantity of first-type readers is less than the preset quantity of readers, it indicates that the reading traffic of the book is not driven by the book recommendation special topic, but is driven by the other reading sources in the reading application. In this case, the present application may calculate the recommendation contribution information of the book recommendation special topic for the book by using at least the first reading conversion quantity and the first-type reader retention quantity that are related to when the book is read through the book recommendation special topic, and the second reading conversion quantity and the second-type reader retention quantity that are related to when the book is read through the other reading source.

In some implementations, for the recommendation contribution information of the book recommendation special topic for the book, the present application may specifically determine the recommendation contribution information by using the following steps: determining a first reading conversion rate of the book in the book recommendation special topic and a second reading conversion rate of the book in the other reading sources based on the first reading conversion quantity, the second reading conversion quantity, first exposure times of target special topic content in the book recommendation special topic, and second exposure times of the book in the other reading sources, the target special topic content being used for recommending the book; determining a minimum reading duration between a reading duration of readers who read the book through the book recommendation special topic and a preset reading duration, and a second correction coefficient corresponding to the second exposure times; and determining the recommendation contribution information of the book recommendation special topic for the book based on the first reading conversion rate, the second reading conversion rate, the first-type reader retention quantity, the second-type reader retention quantity, the minimum reading duration, and the second correction coefficient.

In other words, to accurately analyze a specific reading situation of the book through the book recommendation special topic, the present application may first determine target special topic content in the book recommendation special topic for recommending the book. Then, a first exposure times of the target special topic content within the first preset historical period may be determined, and a ratio of the first reading conversion quantity to the first exposure times of the target special topic content may be used to determine the first reading conversion rate of the book in the book recommendation special topic. In addition, second exposure times of the book in the other reading sources within the first preset historical period may be determined, and a ratio of the second reading conversion quantity to the second exposure times of the book in the other reading sources may be used to determine the second reading conversion rate of the book in the other reading sources.

In addition, as different exposure times may also affect a quantity of readers of the book, and the reading traffic of the book is not driven by the book recommendation special topic, but is driven by the other reading sources in the reading application, the present application may set a suitable adjustment coefficient for the second exposure times of the book in the other reading sources, to use the coefficient as the second correction coefficient in the present application.

The recommendation contribution information brought about by the book recommendation special topic for the book is also affected by a specific reading duration of the book read through the book recommendation special topic. Therefore, the present application may further obtain a specific reading duration of each of the first-type readers who read the target book through the book recommendation special topic within the first preset historical period, to use the specific reading duration as the reading duration of the readers in the present application. Then, a minimum reading duration between the reading duration of each of the readers and a preset reading duration (for example, 30 minutes) may be determined.

Further, the recommendation contribution information of the book recommendation special topic for the book is determined based on a product of a difference between the first reading conversion rate and the second reading conversion rate, a difference between the first-type reader retention quantity and the second-type reader retention quantity, the minimum reading duration, and the second correction coefficient.

Exemplarily, when the reading contribution proportion of the book recommendation special topic for the book is less than the preset reading contribution proportion (for example, 80%), or the total quantity of first-type readers is less than the preset quantity of readers (for example, 800), that is, the reading traffic of the book is driven by the other reading sources in the reading application, a calculation method for the recommendation contribution information of the book recommendation special topic for the book may be as follows:

$$( 0.19 + ctr 1 - ctr 2 ) * ( 0.09 + cvr 1 - cvr 2 ) * min ( duration , 30 ) * gama 2.$$

In the foregoing formula, ctr1 may be the first reading conversion rate of the book in the book recommendation special topic, ctr2 may be the second reading conversion rate of the book in the other reading sources, cvr1 may be the first-type reader retention quantity of the book in the book recommendation special topic, may cvr2 be the second-type reader retention quantity of the book in the other reading sources, duration may be the reading duration of each of the first-type readers who read the book through the book recommendation special topic within the first preset historical period, min(duration, 30) may be the minimum reading duration between the reading duration of the readers who read the book through the book recommendation special topic and the preset reading duration, and gama2 may be the second correction coefficient.

According to one or more embodiments of the present application, considering that a search bar is provided in the reading application to support the user to search for reading related data, when the user directly searches for related information about a specific book in the search bar of the reading application, the book and target special topic content in the book recommendation special topic for recommending the book may be found, so that the user can click the found specific book or the target special topic content for recommending the book to read.

It can be learned that a specific suitable recommendation form of any book is also affected by a specific reading situation after the target special topic content in the book recommendation special topic is searched. Therefore, to ensure efficient and accurate book recommendation, for any book, the present application may further determine second reading data of the book after target special topic content in the book recommendation special topic is searched, the target special topic content being used for recommending the book; and determine search contribution information of the book recommendation special topic for the book based on the second reading data.

In other words, for any book, by analyzing historical search information of the book within a specific historical period, a specific reading situation of the user for each piece of search information in a specific search page from which the target special topic content for recommending the book can be searched can be determined, to determine the second reading data after the target special topic content is searched. The second reading data may indicate an actual reading situation of each piece of search information in the specific search page being read by the user after the target special topic content for recommending the book in the book recommendation special topic is searched.

Then, by analyzing the second reading data after the target special topic content is searched, specific reading information of the user for each search result displayed in the specific search page after the target special topic content is searched can be obtained, where the specific reading information includes actual reading information of the target special topic content read by the user.

Further, by performing comprehensive analysis on the actual reading information of the target special topic content read by the user after the target special topic content is searched and the actual reading information of another search result in the same search page read by the user after the target special topic content is searched, the search contribution information of the book recommendation special topic for the book can be determined.

It may be understood that for determining the first reading data of the book in the plurality of reading sources, determining the recommendation contribution information of the book recommendation special topic for the book based on the first reading data, determining the second reading data after the target special topic content in the book recommendation special topic is searched, and determining the search contribution information of the book recommendation special topic for the book based on the second reading data, are separate determination steps of the recommendation contribution information and the search contribution information of the book recommendation special topic for the book, and there is no sequential relationship between the two steps. The two steps may be performed simultaneously, or may be performed in sequence. This is not limited in the present application.

It can be learned from the foregoing content that whether any book is suitable for being recommended by using the book recommendation special topic is affected by an actual recommendation situation of the book recommendation special topic for the book and an actual search situation of target special topic content for recommending the book in the book recommendation special topic. Therefore, a step of determining a recommendation form of the book may specifically be: determining a recommendation form of the book based on the recommendation contribution information and the search contribution information.

In other words, the present application may perform comprehensive analysis on the recommendation contribution information and the search contribution information of the book recommendation special topic for the book, to determine whether a proportion of a reading traffic of the book brought about by the book recommendation special topic in a sum of reading traffic of the book exceeds a preset suitable recommendation indicator, thereby analyzing whether the book is suitable for being recommended by using the book recommendation special topic. If the book recommendation special topic can bring a large amount of user reading traffic when the book is recommended by using the book recommendation special topic, it indicates that the book recommendation special topic is suitable for recommending the book. In this case, the book recommendation special topic may be determined as a suitable recommendation form of the book.

As an optional implementation of the present application, to improve the efficiency and accuracy of book recommendation, the present application may separately describe in detail a specific process of determining the second reading data after the target special topic content for recommending the book in the book recommendation special topic is searched, and determining the search contribution information of the book recommendation special topic for the book based on the second reading data.

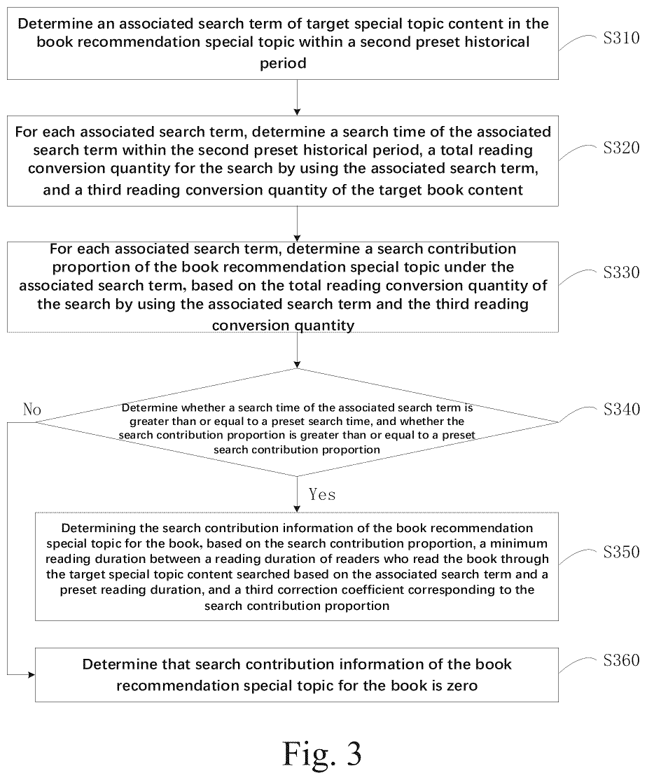

FIG. 3 is a flowchart of a process of determining the second reading data and the search contribution information of the book recommendation special topic for the book according to an embodiment of the present application. As shown in FIG. 3, the method may specifically include the following steps.

In S310, an associated search term of target special topic content in the book recommendation special topic within a second preset historical period is determined.

For any book, when the present application uses each search term to search for the book in a search bar of a reading application, each target special topic content for recommending the book in the book recommendation special topic may be found, so that the user reads the recommended book through the found target special topic content. It can be learned that an actual reading traffic after book recommendation is also affected by a specific search situation of each target special topic content in the book recommendation special topic.

To accurately analyze a specific reading situation of the book after the target special topic content is searched, the present application may preset a historical duration to determine the second preset historical period in the present application, for example, the recent 14 days.

It should be noted that the first preset historical period, the second preset historical period, and the third preset historical period mentioned in the present application may be historical periods of a same duration, or may be historical periods of different durations. This is not limited in the present application.

Then, for each of the target special topic content for recommending the book in the book recommendation special topic, by analyzing each search operation performed by each user within the second preset historical period, each search term from which each target special topic content can be searched may be determined, to be used as the associated search term of the target special topic content within the second preset historical period.

In other words, after search is performed by using the associated search term in the reading application, a search result displayed at least includes at least one target special topic content for recommending the book in the book recommendation special topic.

In S320, for each associated search term, search times of the associated search term within the second preset historical period, a total reading conversion quantity for the search by using the associated search term, and a third reading conversion quantity of the target special topic content are determined.

For each associated search term, search times of the associated search term within the second preset historical period may be first determined, to indicate a number of times that the target special topic content in the book recommendation special topic is searched. In addition, after the target special topic content is searched by using the associated search term, the user may be supported to read the recommended book through the target special topic content, or may be supported to read another search result searched by using the associated search term. In this case, by analyzing a quantity of first-type readers who read the book through the target special topic content after the target special topic content is searched by using the associated search term, the third reading conversion quantity of the target special topic content can be obtained. The third reading conversion quantity may be a quantity of first-type readers who read the book through the target special topic content searched by using an associated search term and whose number of read pages is greater than a preset number of pages.

In addition, a total quantity of search results searched by using the associated search term that are read by the user is analyzed, to obtain the total reading conversion quantity for the search by using the associated search term.

The search times of each associated search term within the second preset historical period, the total reading conversion quantity for the search by using the associated search term, and the third reading conversion quantity of the target special topic content may all affect a specific search situation of the target special topic content in the book recommendation special topic, to be used as the second reading data after the target special topic content is searched.

In S330, for each associated search term, a search contribution proportion of the book recommendation special topic for the book under the associated search term is determined based on the total reading conversion quantity and the third reading conversion quantity for the search by using the associated search term.

For each associated search term, a search contribution proportion of the book recommendation special topic for the book under the associated search term is determined based on a ratio of the third reading conversion quantity of the target special topic content searched by using the associated search term to the total reading conversion quantity for the search by using the associated search term.

In S340, it is determined whether the search times of the associated search term is greater than or equal to a preset search time, and whether the search contribution proportion is greater than or equal to a preset search contribution proportion. If yes, step S350 is performed; or if no, step S360 is performed.

The target special topic content in the book recommendation special topic are different in their search frequencis, and a determination criterion for whether the book recommendation special topic is suitable for recommending the book is different. Therefore, for each associated search term, the present application may analyze a specific search frequency of each target special topic content in the book recommendation special topic by determining whether search times of the associated search term is greater than or equal to a preset search time, and whether a search contribution proportion of the book recommendation special topic for the book under the associated search term is greater than or equal to a preset search contribution proportion.

In S350, search contribution information of the book recommendation special topic for the book is determined based on the search contribution proportion, a minimum reading duration between a reading duration of readers who read the book through the target special topic content searched by using the associated search term and a preset reading duration, and a third correction coefficient corresponding to the search contribution proportion.

If the search times of the associated search term is greater than or equal to the preset search time, and the search contribution proportion of the book recommendation special topic for the book under the associated search term is greater than or equal to the preset search contribution proportion, it indicates that the target special topic content in the book recommendation special topic is frequently searched in the reading application, that is, when the book is recommended through the book recommendation special topic, a large amount of users can be attracted to read the book.

The search contribution information brought about by the target special topic content in the book recommendation special topic for the book is also affected by a specific reading duration of the book read through the book recommendation special topic. Therefore, the present application may further obtain a specific reading duration of each of the first-type readers who read the book through the book recommendation special topic within the first preset historical period, to use the specific reading duration as the reading duration of the readers in the present application. Then, a minimum reading duration between the reading duration of each of the readers and a preset reading duration (for example, 30 minutes) may be determined.

In addition, as different search frequencies may also affect a quantity of readers of the book, the present application may set a suitable adjustment coefficient for the search contribution proportion of the book recommendation special topic for the book under the associated search term, to use the coefficient as the third correction coefficient in the present application.

Further, the search contribution information of the book recommendation special topic for the book is determined based on a product of the search contribution proportion of the book recommendation special topic for the book under the associated search term, the minimum reading duration, and the third correction coefficient.

Exemplarily, when the search times of the associated search term (denoted as search PV) is greater than or equal to the preset search time (for example, 9 times), and the search contribution proportion is greater than or equal to the preset search contribution proportion (for example, 10%), a calculation method for the search contribution information of the book recommendation special topic for the book may be as follows: contribution_ratio*min(duration, 30)*gama3.

In the foregoing formula, contribution_ratio may be the search contribution proportion of the book recommendation special topic for the book under an associated search term, duration may be the reading duration of each of the first-type readers who reads the book through each target special topic content in the book recommendation special topic that is searched by using the associated search term within the second preset historical period, min(duration, 30) may be the minimum reading duration between the reading duration of the readers who read the book through each target special topic content in the book recommendation special topic and the preset reading duration, and gama3 may be the third correction coefficient.

In S360, it is determined that the search contribution information of the book recommendation special topic for the book is zero.

If the search times of the associated search term is less than the preset search time, or the search contribution proportion of the book recommendation special topic for the book under the associated search term is less than the preset search contribution proportion, it indicates that each target special topic content in the book recommendation special topic is not frequently searched in the reading application, that is, the target special topic content in the book recommendation special topic has no search impact. Therefore, the present application may directly determine that the search contribution information of the book recommendation special topic for the book is zero.

In addition, considering that different search terms are used in the reading application, a same target special topic content in the book recommendation special topic may be searched, that is, there are a plurality of associated search terms for the same target special topic content. In this case, for each associated search term of the target special topic content, a corresponding search contribution information may be determined for a specific search recommendation situation of the book recommendation special topic for the book in the foregoing manner, so that there are a plurality of search contribution information for the same target special topic content in the book recommendation special topic.

Therefore, to ensure accuracy of the search contribution information of the book recommendation special topic for the book, the present application may use a maximum value of search contribution information of the target special topic content under each associated search term as the search contribution information of the book recommendation special topic for the book.

In other words, for the search contribution information of each target special topic content in the book recommendation special topic, a maximum value of search contribution information of the same target special topic content under each associated search term may be used as final search contribution information of the target special topic content. In this case, final search contribution information of each target special topic content in the book recommendation special topic is analyzed, to determine the search contribution information of the book recommendation special topic for the book.

In some implementations, for any book, the book recommendation special topic may include but is not limited to topic content, book list content, and multimedia content for recommending the book. In other words, in the book recommendation special topic, the book may be recommended in three forms: the topic content, the book list content, and the multimedia content. The multimedia content may include but is not limited to a book recommendation video, a book excerpt, a book review, and a chapter card. This is not limited in the present application.

In this case, when the recommendation contribution information of the book recommendation special topic for the book is analyzed, related first reading data of reading the book through the topic content, the book list content, and the multimedia content in the book recommendation special topic may be separately analyzed, to separately obtain first recommendation contribution information of the topic content in the book recommendation special topic for the book, second recommendation contribution information of the book list content in the book recommendation special topic for the book, and third recommendation contribution information of the multimedia content in the book recommendation special topic for the book. In other words, for any book, the recommendation contribution information of the book recommendation special topic for the book may include the three types of information: the first recommendation contribution information of the topic content for the book, the second recommendation contribution information of the book list content for the book, and the third recommendation contribution information of the multimedia content for the book.

Further, determining a recommendation form of the book based on the recommendation contribution information specifically may be: determining the recommendation form of the book as at least one of the topic content, the book list content, and the multimedia content based on the first recommendation contribution information, the second recommendation contribution information, and the third recommendation contribution information.

In other words, the present application may separately analyze the first recommendation contribution information, the second recommendation contribution information, and the third recommendation contribution information, to separately determine whether a proportion of a first reading traffic of the book brought about by the topic content in the book recommendation special topic in a sum of reading traffic of the book exceeds a preset suitable recommendation indicator, whether a proportion of a second reading traffic of the book brought about by the book list content in the book recommendation special topic in the sum of reading traffic of the book exceeds the preset suitable recommendation indicator, and whether a proportion of a third reading traffic of the book brought about by the multimedia content in the book recommendation special topic in the sum of reading traffic of the book exceeds the preset suitable recommendation indicator, thereby analyzing which of the topic content, the book list content, and the multimedia content in the book recommendation special topic is suitable for recommending the book, to determine that the suitable recommendation form of the book may be at least one of the topic content, the book list content, and the multimedia content in the book recommendation special topic.

In addition, for a recommendation form of any book, the present application refers to not only the recommendation contribution information of the book recommendation special topic for the book that is determined based on the first reading data of the book in the plurality of reading sources, but also search contribution information of the book recommendation special topic for the book that is determined based on the second reading data of the book after the target special topic content in the book recommendation special topic is searched.

In this case, when the book recommendation special topic includes the topic content, the book list content, and the multimedia content for recommending the book, for the recommendation contribution information of the book recommendation special topic for the book, related first reading data of reading the book through the topic content, the book list content, and the multimedia content in the book recommendation special topic may be separately analyzed, to separately obtain first recommendation contribution information of the topic content in the book recommendation special topic for the book, second recommendation contribution information of the book list content in the book recommendation special topic for the book, and third recommendation contribution information of the multimedia content in the book recommendation special topic for the book. In other words, for any book, the recommendation contribution information of the book recommendation special topic for the book may include the three types of information: the first recommendation contribution information of the topic content for the book, the second recommendation contribution information of the book list content for the book, and the third recommendation contribution information of the multimedia content for the book.

For the search contribution information of the book recommendation special topic for the book, related second reading data after topic content, book list content, and multimedia content for recommending the book in the book recommendation special topic are searched may be separately analyzed, to separately obtain first search contribution information of the topic content in the book recommendation special topic for the book, second search contribution information of the book list content in the book recommendation special topic for the book, and third search contribution information of the multimedia content in the book recommendation special topic for the book. In other words, for any book, the search contribution information of the book recommendation special topic for the book may include the three types of information: the first search contribution information of the topic content for the book, the second search contribution information of the book list content for the book, and the third search contribution information of the multimedia content for the book.

Further, determining a recommendation form of the book based on the recommendation contribution information and the search contribution information specifically may be: determining the recommendation form of the book as at least one of the topic content, the book list content, and the multimedia content based on the first recommendation contribution information, the second recommendation contribution information, and the third recommendation contribution information, and the first search contribution information, the second search contribution information, and the third search contribution information.

In other words, the present application may perform comprehensive analysis on the first recommendation contribution information and the first search contribution information, to determine whether a proportion of a first reading traffic of the book brought about by the topic content in the book recommendation special topic in a sum of reading traffic of the book exceeds a preset suitable recommendation indicator. The present application may perform comprehensive analysis on the second recommendation contribution information and the second search contribution information, to determine whether a proportion of a second reading traffic of the book brought about by the book list content in the book recommendation special topic in the sum of reading traffic of the book exceeds the preset suitable recommendation indicator. The present application may perform comprehensive analysis on the third recommendation contribution information and the third search contribution information, to determine whether a proportion of a third reading traffic of the book brought about by the multimedia content in the book recommendation special topic in the sum of reading traffic of the book exceeds the preset suitable recommendation indicator. In this case, it can be determined which of the topic content, the book list content, and the multimedia content in the book recommendation special topic is suitable for recommending the book, to determine that the suitable recommendation form of the book may be at least one of the topic content, the book list content, and the multimedia content in the book recommendation special topic.

In addition, after a recommendation form of a large quantity of historical books in the reading application is determined, to ensure accurate recommendation of new books in the reading application, the present application may further determine, based on attributes and recommendation forms of the historical books, attributes of books to be recommended that are suitable for the topic content, the book list content, and the multimedia content in the book recommendation special topic.

In other words, for each historical book whose recommendation form has been determined in the reading application, the present application may first determine attribute information such as a subject matter, a type, and a style of the historical book, and determine which of the topic content, the book list content, and the multimedia content in the book recommendation special topic is used as the recommendation form of the historical book. In this case, a first type of historical books that are recommended by using the topic content in the book recommendation special topic, a second type of historical books that are recommended by using the book list content in the book recommendation special topic, and a third type of historical books that are recommended by using the multimedia content in the book recommendation special topic may be obtained. Then, attribute information such as the subject matter, the type, and the style of the first type of historical books, the second type of historical books, and the third type of historical books is separately analyzed, to determine attributes of books to be recommended that are suitable for the topic content, the book list content, and the multimedia content in the book recommendation special topic, so that when a new book is subsequently recommended in the reading application, a suitable recommendation form of the new book can be quickly determined based on a matching relationship between an attribute of the new book and the attributes of books to be recommended that are suitable for the topic content, the book list content, and the multimedia content in the book recommendation special topic.

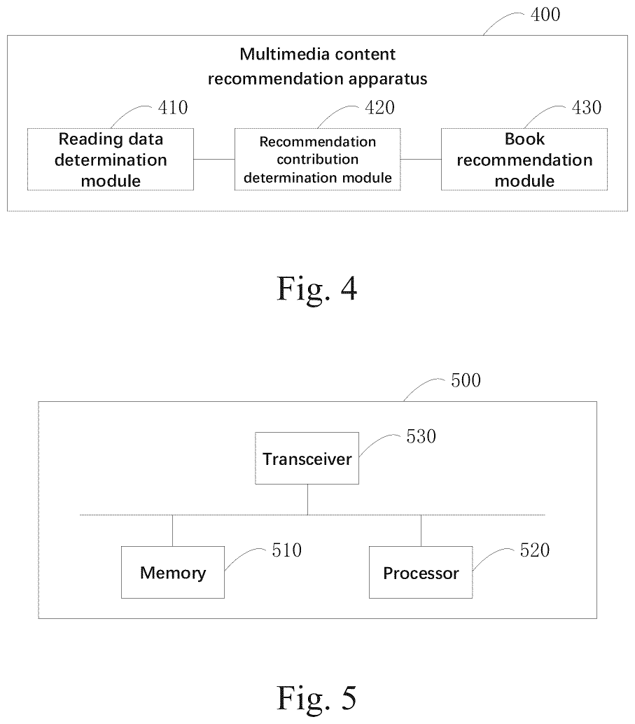

FIG. 4 is a schematic block diagram of a multimedia content recommendation apparatus according to an embodiment of the present application. As shown in FIG. 4, the multimedia content recommendation apparatus 400 may include:
a reading data determination module 410, configured to determine, for any book, first reading data of the book in a plurality of reading sources, where the reading sources at least include a book recommendation special topic;
a recommendation contribution determination module 420, configured to determine recommendation contribution information of the book recommendation special topic for the book based on the first reading data; and
a book recommendation module 430, configured to determine a recommendation form of the book based on the recommendation contribution information.

In some implementations, the reading data determination module 410 may be specifically configured to:
determine a reading source of the book in a reading application, where the reading source at least includes the book recommendation special topic;
determine a total quantity of first-type readers who read the book through the book recommendation special topic within a first preset historical period, a first reading conversion quantity and a first-type reader retention quantity of the book in the book recommendation special topic; and
determine a total quantity of second-type readers who read the book through other reading sources within the first preset historical period, a second reading conversion quantity and a second-type reader retention quantity of the book in the other reading sources.

In some implementations, the first reading conversion quantity is a quantity of first-type readers who read the book through the book recommendation special topic and whose number of read pages is greater than a preset number of pages; and the second reading conversion quantity is a quantity of second-type readers who read the book through the other reading source and whose number of read pages is greater than the preset number of pages.

In some implementations, the recommendation contribution determination module 420 may include:
a reading contribution proportion determination unit, configured to determine a reading contribution proportion of the book recommendation special topic for the book based on the total quantity of first-type readers and the total quantity of second-type readers;
a first recommendation contribution determination unit, configured to determine the recommendation contribution information of the book recommendation special topic for the book at least based on the first reading conversion quantity and the first-type reader retention quantity, if the reading contribution proportion is greater than or equal to a preset reading contribution proportion and the total quantity of first-type readers is greater than or equal to a preset quantity of readers; and
a second recommendation contribution determination unit, configured to, if otherwise, determine the recommendation contribution information of the book recommendation special topic for the book at least based on the first reading conversion quantity, the second reading conversion quantity, the first-type reader retention quantity, and the second-type reader retention quantity.

In some implementations, the first recommendation contribution determination unit may be specifically configured to:
determine a first reading conversion rate of the book in the book recommendation special topic based on the first reading conversion quantity and first exposure times of target special topic content in the book recommendation special topic, the target special topic content being used for recommending the book;
determine a minimum reading duration between a reading duration of readers who read the book through the book recommendation special topic and a preset reading duration, and a first correction coefficient corresponding to the first exposure times; and
determine the recommendation contribution information of the book recommendation special topic for the book based on the first reading conversion rate, the first-type reader retention quantity, the minimum reading duration, and the first correction coefficient.

In some implementations, the second recommendation contribution determination unit may be specifically configured to:
determine a first reading conversion rate of the book in the book recommendation special topic and a second reading conversion rate of the book in the other reading sources based on the first reading conversion quantity, the second reading conversion quantity, first exposure times of target special topic content in the book recommendation special topic, and second exposure times of the book in the other reading sources, the target special topic content being used for recommending the book;
determine a minimum reading duration between a reading duration of readers who read the book through the book recommendation special topic and a preset reading duration, and a second correction coefficient corresponding to the second exposure times; and
determine the recommendation contribution information of the book recommendation special topic for the book based on the first reading conversion rate, the second reading conversion rate, the first-type reader retention quantity, the second-type reader retention quantity, the minimum reading duration, and the second correction coefficient.

In some implementations, the multimedia content recommendation apparatus 400 may further include:
a search data determination module, configured to determine second reading data of the book after target special topic content in the book recommendation special topic is searched, the target special topic content being used for recommending the book; and
a search contribution determination module, configured to determine search contribution information of the book recommendation special topic for the book based on the second reading data.

Correspondingly, the book recommendation module 430 may be specifically configured to:
determine a recommendation form of the book based on the recommendation contribution information and the search contribution information.

In some implementations, the search data determination module may be specifically configured to:
determine an associated search term of target special topic content in the book recommendation special topic within a second preset historical period; and
for each associated search term, determine a search time of the associated search term within the second preset historical period, a total reading conversion quantity for the search by using the associated search term, and a third reading conversion quantity of the target special topic content.

In some implementations, the search contribution determination module may be specifically configured to:
for each associated search term, determine a search contribution proportion of the book recommendation special topic for the book under the associated search term based on the total reading conversion quantity for the search by using the associated search term and the third reading conversion quantity;
if a search time of the associated search term is greater than or equal to a preset search time, and the search contribution proportion is greater than or equal to a preset search contribution proportion, determine search contribution information of the book recommendation special topic for the book based on the search contribution proportion, a minimum reading duration between a reading duration of readers who read the book through the target special topic content searched by using the associated search term and a preset reading duration, and a third correction coefficient corresponding to the search contribution proportion; or
otherwise, determine that the search contribution information of the book recommendation special topic for the book is zero.

In some implementations, if there are a plurality of associated search terms for the target special topic content in the book recommendation special topic, the search contribution determination module may be further configured to:
use a maximum value of search contribution information of the target special topic content under each associated search term as search contribution information of the book recommendation special topic for the book.

In some implementations, the book recommendation special topic includes topic content, book list content, and multimedia content for recommending the book, and the recommendation contribution information of the book recommendation special topic for the book includes first recommendation contribution information of the topic content for the book, second recommendation contribution information of the book list content for the book, and third recommendation contribution information of the multimedia content for the book.

Correspondingly, the book recommendation module 430 may be specifically configured to:
determine the recommendation form of the book as at least one of the topic content, the book list content, and the multimedia content based on the first recommendation contribution information, the second recommendation contribution information, and the third recommendation contribution information.

In some implementations, the book recommendation special topic includes topic content, book list content, and multimedia content for recommending the book;
the recommendation contribution information of the book recommendation special topic for the book includes first recommendation contribution information of the topic content for the book, second recommendation contribution information of the book list content for the book, and third recommendation contribution information of the multimedia content for the book; and
the search contribution information of the book recommendation special topic for the book includes first search contribution information of the topic content for the book, second search contribution information of the book list content for the book, and third search contribution information of the multimedia content for the book;
correspondingly, the book recommendation module 430 may be specifically configured to:
determine the recommendation form of the book as at least one of the topic content, the book list content, and the multimedia content based on the first recommendation contribution information, the second recommendation contribution information, and the third recommendation contribution information, and the first search contribution information, the second search contribution information, and the third search contribution information.

In some implementations, if the recommendation form of the book is to recommend the book by using the target special topic content in the book recommendation special topic, the target special topic content at least includes a cover, a name, and a recommendation text of the book.

In some implementations, the multimedia content recommendation apparatus 400 may further include:
a to-be-recommended attribute determination module, configured to determine, based on attributes and recommendation forms of historical books, attributes of books to be recommended that are suitable for the topic content, the book list content, and the multimedia content in the book recommendation special topic.

In the embodiments of the present application, for any book, first reading data of the book in a plurality of reading sources at least including a book recommendation special topic is first determined, to determine a recommendation contribution degree of the book recommendation special topic for the book. Then, a most suitable recommendation form of the book is determined based on the recommendation contribution degree, thereby improving the efficiency and accuracy of book recommendation. By determining a most suitable recommendation form for any book, a specific recommendation requirement of different types of books can be met, and it is ensured that the book has reading attraction after being recommended in the most suitable recommendation form, thereby enhancing effectiveness of reading after book recommendation.

It should be understood that the apparatus embodiment may correspond to the method embodiment of the present application, and similar descriptions may refer to the method embodiment of the present application. To avoid repetition, details are not described herein again.

Specifically, the apparatus 400 shown in FIG. 4 may perform any method embodiment provided in the present application, and the foregoing and other operations and/or functions of each module in the apparatus 400 shown in FIG. 4 are respectively intended to implement corresponding processes of the above method embodiment. For the sake of brevity, details are not described herein again.

The foregoing describes the above method embodiment of the embodiments of the present application from the perspective of a functional module with reference to the accompanying drawings. It should be understood that the functional module may be implemented in a form of hardware, may be implemented by instructions in a form of software, or may be implemented by a combination of hardware and software modules. Specifically, each step in the method embodiment of the embodiments of the present application may be completed by an integrated logic circuit of hardware in a processor and/or instructions in a form of software, and the steps of the method disclosed in the embodiments of the present application may be directly embodied as being completed by a hardware decoding processor, or completed by a combination of hardware and a software module in the decoding processor. Optionally, the software module may be located in a mature storage medium in the art, such as a random access memory, a flash memory, a read-only memory, a programmable read-only memory, an electrically erasable programmable memory, or a register. The storage medium is located in a memory, and a processor reads information in the memory and completes the steps in the above method embodiment in combination with hardware of the processor.

FIG. 5 is a schematic block diagram of an electronic device according to an embodiment of the present application.

As shown in FIG. 5, the electronic device 500 may include:
a memory 510 and a processor 520, where the memory 510 is configured to store a computer program, and transmit program code to the processor 520. In other words, the processor 520 may call and run the computer program from the memory 510, to implement the method in the embodiments of the present application.

For example, the processor 520 may be configured to perform the above method embodiment according to an instruction in the computer program.

In some embodiments of the present application, the processor 520 may include but is not limited to:
a general-purpose processor, a digital signal processor (DSP), an application-specific integrated circuit (ASIC), a field programmable gate array (FPGA) or another programmable logical device, a discrete gate or transistor logic device, or a discrete hardware component.

In some embodiments of the present application, the memory 510 includes but is not limited to:
a volatile memory and/or a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), which is used as an external cache. By way of example but not limitation, many forms of RAM are available, such as a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous connection dynamic random access memory (synch link DRAM, SLDRAM), and a direct memory bus random access memory (Direct Rambus RAM, DR RAM).

In some embodiments of the present application, the computer program may be divided into one or more modules, the one or more modules are stored in the memory 510, and are executed by the processor 520, to complete the method provided in the present application. The one or more modules may be a series of computer program instruction segments that can complete specific functions, and the instruction segments are used to describe an execution process of the computer program in the electronic device 500.

As shown in FIG. 5, the electronic device may further include:
a transceiver 530, which may be connected to the processor 520 or the memory 510.

The processor 520 may control the transceiver 530 to communicate with another device. Specifically, the processor 520 may send information or data to the another device, or receive information or data sent by the another device. The transceiver 530 may include a transmitter and a receiver. The transceiver 530 may further include one or more antennas.

It should be understood that each component in the electronic device 500 is connected through a bus system, where the bus system includes, in addition to a data bus, a power bus, a control bus, and a status signal bus.

The present application further provides a computer storage medium having a computer program stored thereon, where when the computer program is executed by a computer, the computer is enabled to perform the method in the method embodiment.

An embodiment of the present application further provides a computer program product including a computer program/instructions, where when the computer program/instructions are executed by a computer, the computer is enabled to perform the method in the method embodiment.

When implemented in the form of software, all or some of the embodiments may be implemented in the form of a computer program product. The computer program product includes one or more computer instructions. When the computer program instructions are loaded and executed on a computer, all or some of the processes or functions according to the embodiments of the present application are generated. The computer may be a general-purpose computer, a dedicated computer, a computer network, or another programmable apparatus. The computer instructions may be stored in a computer-readable storage medium, or may be transmitted from one computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device such as a server or a data center integrating one or more usable media. The usable medium may be a magnetic medium (for example, a floppy disk, a hard disk, or a magnetic tape), an optical medium (for example, a digital video disc (DVD)), or a semiconductor medium (for example, a solid state disk (SSD)), or the like.

The foregoing descriptions are merely specific implementations of the present application, but are not intended to limit the protection scope of the present application. Any variation or replacement readily figured out by a person skilled in the art within the technical scope disclosed in the present application shall fall within the protection scope of the present application. Therefore, the protection scope of the present application shall be subject to the protection scope of the claims.

1. A multimedia content recommendation method, comprising:
determining, for any book, first reading data of the book in a plurality of reading sources, the reading sources comprising at least a book recommendation special topic;
determining recommendation contribution information of the book recommendation special topic for the book based on the first reading data; and
determining a recommendation form of the book based on the recommendation contribution information.

2. The method according to claim 1, wherein the determining first reading data of the book in a plurality of reading sources comprises:
determining reading sources of the book in a reading application, the reading sources comprising at least the book recommendation special topic;
determining a total quantity of first-type readers who read the book through the book recommendation special topic within a first preset historical period, and a first reading conversion quantity and a first-type reader retention quantity of the book in the book recommendation special topic; and
determining a total quantity of second-type readers who read the book through other reading sources within the first preset historical period, and a second reading conversion quantity and a second-type reader retention quantity of the book in the other reading sources.

3. The method according to claim 2, wherein the first reading conversion quantity is a quantity of first-type readers who read the book through the book recommendation special topic and whose number of read pages is greater than a preset number of pages; and the second reading conversion quantity is a quantity of second-type readers who read the book through the other reading sources and whose number of read pages is greater than the preset number of pages.

4. The method according to claim 2, wherein the determining recommendation contribution information of the book recommendation special topic for the book based on the first reading data comprises:
determining a reading contribution proportion of the book recommendation special topic for the book based on the total quantity of first-type readers and the total quantity of second-type readers; and
if the reading contribution proportion is greater than or equal to a preset reading contribution proportion, and the total quantity of first-type readers is greater than or equal to a preset quantity of readers, determining the recommendation contribution information of the book recommendation special topic for the book at least based on the first reading conversion quantity and the first-type reader retention quantity;
otherwise, determining the recommendation contribution information of the book recommendation special topic for the book at least based on the first reading conversion quantity, the second reading conversion quantity, the first-type reader retention quantity, and the second-type reader retention quantity.

5. The method according to claim 4, wherein the determining recommendation contribution information of the book recommendation special topic for the book at least based on the first reading conversion quantity and the first-type reader retention quantity comprises:
determining a first reading conversion rate of the book in the book recommendation special topic based on the first reading conversion quantity and a first exposure time of target special topic content in the book recommendation special topic, the target special topic content being for recommending the book;
determining a minimum reading duration between a reading duration of readers who read the book through the book recommendation special topic and a preset reading duration, and a first correction coefficient corresponding to a first exposure time; and
determining the recommendation contribution information of the book recommendation special topic for the book based on the first reading conversion rate, the first-type reader retention quantity, the minimum reading duration, and the first correction coefficient.

6. The method according to claim 4, wherein the determining recommendation contribution information of the book recommendation special topic for the book at least based on the first reading conversion quantity, the second reading conversion quantity, the first-type reader retention quantity, and the second-type reader retention quantity comprises:
determining a first reading conversion rate of the book in the book recommendation special topic and a second reading conversion rate of the book in the other reading sources based on the first reading conversion quantity, the second reading conversion quantity, a first exposure time of target special topic content in the book recommendation special topic, and a second exposure time of the book in the other reading sources, the target special topic content being for recommending the book;
determining a minimum reading duration between a reading duration of readers who read the book through the book recommendation special topic and a preset reading duration, and a second correction coefficient corresponding to a second exposure time; and
determining the recommendation contribution information of the book recommendation special topic for the book based on the first reading conversion rate, the second reading conversion rate, the first-type reader retention quantity, the second-type reader retention quantity, the minimum reading duration, and the second correction coefficient.

7. The method according to claim 1, further comprising:
determining second reading data of the book after target special topic content in the book recommendation special topic is searched, the target special topic content being for recommending the book; and
determining search contribution information of the book recommendation special topic for the book based on the second reading data;
the determining a recommendation form of the book based on the recommendation contribution information comprises:
determining the recommendation form of the book based on the recommendation contribution information and the search contribution information.

8. The method according to claim 7, wherein the determining second reading data of the book after target special topic content in the book recommendation special topic is searched comprises:
determining an associated search term for the target special topic content in the book recommendation special topic within a second preset historical period; and
determining, for each associated search term, a search time of the associated search term within the second preset historical period, and a total reading conversion quantity for the search by using the associated search term and a third reading conversion quantity of the target special topic content.

9. The method according to claim 8, wherein the determining search contribution information of the book recommendation special topic for the book based on the second reading data comprises:
determining, for each associated search term, a search contribution proportion of the book recommendation special topic for the book under the associated search term based on the total reading conversion quantity for the search by using the associated search term and the third reading conversion quantity; and
if a search time of the associated search term is greater than or equal to a preset search time, and the search contribution proportion is greater than or equal to a preset search contribution proportion, determining the search contribution information of the book recommendation special topic for the book based on the search contribution proportion, a minimum reading duration between a reading duration of readers who read the book through the target special topic content searched based on the associated search term and a preset reading duration, and a third correction coefficient corresponding to the search contribution proportion;
otherwise, determining that the search contribution information of the book recommendation special topic for the book is 0.

10. The method according to claim 9, wherein if there are a plurality of associated search terms for the target special topic content in the book recommendation special topic, the determining search contribution information of the book recommendation special topic for the book based on the second reading data further comprises:
using a maximum value of search contribution information of the target special topic content under each of the associated search terms as the search contribution information of the book recommendation special topic for the book.

11. The method according to claim 1, wherein the book recommendation special topic comprises topic content, book list content, and multimedia content for recommending the book, and the recommendation contribution information of the book recommendation special topic for the book comprises first recommendation contribution information of the topic content for the book, second recommendation contribution information of the book list content for the book, and third recommendation contribution information of the multimedia content for the book; and
the determining a recommendation form of the book based on the recommendation contribution information comprises:
determining, based on the first recommendation contribution information, the second recommendation contribution information, and the third recommendation contribution information, the recommendation form of the book as at least one of the topic content, the book list content, and the multimedia content.

12. The method according to claim 7, wherein the book recommendation special topic comprises topic content, book list content, and multimedia content for recommending the book;
the recommendation contribution information of the book recommendation special topic for the book comprises first recommendation contribution information of the topic content for the book, second recommendation contribution information of the book list content for the book, and third recommendation contribution information of the multimedia content for the book;
the search contribution information of the book recommendation special topic for the book comprises first search contribution information of the topic content for the book, second search contribution information of the book list content for the book, and third search contribution information of the multimedia content for the book; and
the determining a recommendation form of the book based on the recommendation contribution information and the search contribution information comprises:
determining, based on the first recommendation contribution information, the second recommendation contribution information, and the third recommendation contribution information, and the first search contribution information, the second search contribution information, and the third search contribution information, the recommendation form of the book as at least one of the topic content, the book list content, and the multimedia content.

13. The method according to claim 1, wherein if a recommendation form of the book is to recommend the book through target special topic content in the book recommendation special topic, the target special topic content comprises at least a cover, a name, and a recommendation text of the book.

14. The method according to claim 1, further comprising:
determining, based on attributes and recommendation forms of historical books, attributes of to-be-recommended books suitable for topic content, book list content, and multimedia content in the book recommendation special topic.

15. An electronic device, comprising:
a processor; and
a memory, configured to store executable instructions of the processor,
wherein the processor is configured to perform a multimedia content recommendation method by executing the executable instructions, comprising:
determining, for any book, first reading data of the book in a plurality of reading sources, the reading sources comprising at least a book recommendation special topic;
determining recommendation contribution information of the book recommendation special topic for the book based on the first reading data; and
determining a recommendation form of the book based on the recommendation contribution information.

16. The electronic device according to claim 15, wherein the determining first reading data of the book in a plurality of reading sources comprises:
determining reading sources of the book in a reading application, the reading sources comprising at least the book recommendation special topic;
determining a total quantity of first-type readers who read the book through the book recommendation special topic within a first preset historical period, and a first reading conversion quantity and a first-type reader retention quantity of the book in the book recommendation special topic; and
determining a total quantity of second-type readers who read the book through other reading sources within the first preset historical period, and a second reading conversion quantity and a second-type reader retention quantity of the book in the other reading sources.

17. The electronic device according to claim 16, wherein the first reading conversion quantity is a quantity of first-type readers who read the book through the book recommendation special topic and whose number of read pages is greater than a preset number of pages; and the second reading conversion quantity is a quantity of second-type readers who read the book through the other reading sources and whose number of read pages is greater than the preset number of pages.

18. A non-transitory computer-readable storage medium having stored thereon a computer program that, when executed by a processor, causes the processor to perform a multimedia content recommendation method, comprising:
determining, for any book, first reading data of the book in a plurality of reading sources, the reading sources comprising at least a book recommendation special topic;
determining recommendation contribution information of the book recommendation special topic for the book based on the first reading data; and
determining a recommendation form of the book based on the recommendation contribution information.

19. The non-transitory computer-readable storage medium according to claim 18, wherein the determining first reading data of the book in a plurality of reading sources comprises:
determining reading sources of the book in a reading application, the reading sources comprising at least the book recommendation special topic;
determining a total quantity of first-type readers who read the book through the book recommendation special topic within a first preset historical period, and a first reading conversion quantity and a first-type reader retention quantity of the book in the book recommendation special topic; and
determining a total quantity of second-type readers who read the book through other reading sources within the first preset historical period, and a second reading conversion quantity and a second-type reader retention quantity of the book in the other reading sources.

20. The non-transitory computer-readable storage medium according to claim 19, wherein the first reading conversion quantity is a quantity of first-type readers who read the book through the book recommendation special topic and whose number of read pages is greater than a preset number of pages; and the second reading conversion quantity is a quantity of second-type readers who read the book through the other reading sources and whose number of read pages is greater than the preset number of pages.
